(19) United States
(12) Patent Application Publication
(10) Pub. No.: US 2021/0088160 A1
(43) Pub. Date: Mar. 25, 2021

(54) CLAMPING COLLAR

(71) Applicant: CAILLAU, ISSY-LES-MOULINEAUX (FR)

(72) Inventors: Nicolas RIGOLLET, ROMORANTIN (FR); Fabrice PREVOT, SELLES SUR CHER (FR)

(21) Appl. No.: 17/027,993

(22) Filed: Sep. 22, 2020

(30) Foreign Application Priority Data
Sep. 23, 2019 (FR) 19 10486

(51) Int. Cl. F16L 23/036

(52) U.S. Cl. CPC F16L 23/036

(57) ABSTRACT

The clamping collar comprises a metal belt configured to be clamped on an object, the belt having an inner recess comprising a bottom delimited by cheeks oriented towards the axis of the belt, the collar having a capacity reserve, formed by a portion of the belt likely to elongate under the effect of a clamping tension of the belt, the capacity reserve being delimited, along the circumferential direction of the belt, by linking portions in which the cheeks are interrupted and having cheek portions oriented towards the axis of the belt.

### BACKGROUND

The disclosure relates to a clamping collar comprising a metal belt configured to be clamped on an object, the belt having an inner recess with a bottom delimited by cheeks oriented towards the axis of the belt. Such a clamping collar is used to clamp an object, for example a pipe fitted on an end-piece, or two tube portions connected together end-to-end or by fitting. This object has an annular bulge which is received in the recess of the belt. The sides of this annular bulge form bearing surfaces against which bear the cheeks which delimit the recess when the object is clamped by the collar. This bearing promotes the safety of the clamping. Regarding an object formed of two object portions, for example two tube portions, abutting in the region of the bulge, this bearing secures this abutment.

The clamping collar can be used in an environment subject to significant temperature variations, for example outdoors or in the engine compartment of a vehicle or on an exhaust line of the engine of a vehicle. Collars of this type are known, for example, from patent documents EP 0 636 826, EP 1 697 672, EP 0 305 232 and EP 2 585 751.

During its use, the collar can be subjected to significant tensile forces. On the one hand, the collar is in principle dimensioned to clamp objects of defined dimensions. However, due to the manufacturing tolerances of these objects, the collar may have to adapt to dimensions slightly different from those for which it is initially dimensioned. Particularly, it may be desirable that the belt slightly elongates to adapt to an object of a diameter slightly larger than expected, while maintaining a suitable clamping. Furthermore, once clamped by the collar, the object can be deformed, in particular due to possible thermal expansions. It is desirable that the collar can accompany these expansions, while maintaining a suitable clamping force.

Flat-strip collars are known, that is to say whose belt is devoid of inner recess and of cheeks, which are provided with capacity reserves formed in corrugations of the radially protruding strip, as in patent documents EP 2 480 355 and EP 0 627 591. Such capacity reserves are generally satisfactory for flat-strip collars, without inner recess and without cheeks. Furthermore, there is known from patent documents WO 2017 149 103, DE 298 16 889U, EP 0 403 379 and U.S. Pat. No. 2,897,569 a clamping collar whose belt has an inner recess delimited by cheeks and a flat-strip part, devoid of cheeks, which serves as a hinge for opening the belt.

### OBJECT AND SUMMARY

There is a need for a collar whose belt has an inner recess delimited by cheeks oriented towards the axis of the belt, which has the capacity to elongate the belt during the clamping of the collar or once the collar is clamped, for the reasons indicated above.

The disclosure aims particularly at proposing a clamping collar, whose belt has an inner recess which is nevertheless provided with a capacity reserve that is reliable and simple to make.

Thus, the disclosure relates to a clamping collar comprising a metal belt configured to be clamped on an object, the belt having an inner recess comprising a bottom delimited by cheeks oriented towards the axis of the belt, the collar having a capacity reserve, formed by a portion of the belt likely to elongate under the effect of a clamping tension of the belt, the capacity reserve being delimited, along the circumferential direction of the belt, by linking portions in which the cheeks are interrupted and the capacity reserve having cheek portions oriented towards the axis of the belt.

The capacity reserve is therefore formed by a portion of the belt delimited at each of its ends by a linking portion in which the cheeks are interrupted. Thus, the portion in which the belt is able to elongate to adapt to increased dimensions of the object clamped by the collar, is delimited and represents a well-defined part of the belt. The capacity reserve can be simple to make since it is thus mechanically decoupled from the rest of the belt. However, the capacity reserve has cheek portions that are oriented towards the axis of the belt. These cheek portions have several functions. On the one hand, they can bear against the bearing surfaces of the object clamped by the collar thus ensuring, in the region of the capacity reserve, the bearing function ensured by the cheeks that delimit the recess. Furthermore, during the elongation of the capacity reserve, the cheek portions tend to move closer to each other along the direction of the axis of the belt, which reinforces the additional bearing thus made in the region of the capacity reserve. In addition, the cheek portions provide rigidity to the capacity reserve. Particularly, they can be dimensioned, in height (radially) and in length (along the circumference of the collar), so as to provide the desired rigidity to the capacity reserve. Being oriented towards the axis of the belt, the cheek portions form wall elements which comprise a dimension (component) oriented parallel to the circumference of the belt, and a dimension (component) inclined with respect to this axis, particularly by being substantially radial. For each cheek portion, the elongation forces to which the capacity reserve is subjected are exerted naturally along the circumferential direction of the belt, but are equally distributed in the height of the cheek portion, according to the component inclined with respect to the axis of the belt. This distribution of the forces impacts the amplitude of deformation of the capacity reserve and tends to modify the inclination of the cheek portion with respect to the axis of the belt, which has the effect of bringing the cheek portions closer to each other. Furthermore, in the linking portions, the belt can be deformed by deformations other than an elongation of its circumference. Particularly, the belt can be folded in the linking portions which can then act as hinges favorable for the mounting of the collar on the object to be clamped.

Optionally, the cheek portions have convex curved edges.

Optionally, the capacity reserve has at least one concave edge portion.

Optionally, the cheek portions are at least partly located axially on either side of said concave edge portion.

Optionally, the concave edge portion extends within the circumferential space requirement of the belt.

Optionally, the capacity reserve has at least one hole.

Optionally, the hole extends up to the cheek portions.

Optionally, the hole has at least one of the following geometric characteristics:
a length at least equal to 30% of the length of the capacity reserve, these lengths being measured along the circumferential direction of the belt, and
a width at least equal to 50% of the width of the belt, these widths being measured along the direction of the axis of the belt.

Optionally, the cheek portions are formed in lobes.

Optionally, at least one of the lobes has an apex located axially in line with a bottom area of the concavity of the concave edge portion.

Optionally, the belt carries a protruding lug in the vicinity of a first end and a hook in the vicinity of a second end, the hook having a front wall and a common part, the front wall being intended to be retained behind the lug while the hook is hooked on the lug to keep the collar in the clamped state, the common part linking the front wall to the belt and having a gripping surface protruding radially outwardly and two lateral borders which extend axially on either side of the gripping surface by being radially set back from the gripping surface.

Optionally, the gripping surface is formed at the rear of a boss of the common part.

Optionally, the clamping collar is formed in one piece from a metal strip.

The capacity reserve can remain within the circumferential space requirement of the belt, that is in the cylindrical outer envelope of the belt, particularly without forming a radially protruding corrugation. Particularly, the concave edge portion of the capacity reserve can be formed in the cylindrical ring formed by the bottom of the recess. Thus, it may not protrude radially relative to the rest of the belt, and may ensure a bearing continuity on the clamped object using the collar, this continuity being possibly interrupted only locally by the concavity of the concave edge portion, for example the hole. However, the geometry of the concave edge portion and the presence of the cheek portions of the capacity reserve neutralize this interruption.

The capacity reserve is extremely easy to manufacture. For example, as the belt is made from a metal strip, it suffices, prior to the rolling of the strip forming the belt, to cut out notches on the longitudinal edges of the strip and to make the concave edge portion by cutting or punching. The notches define the areas in which the cheeks are interrupted, that is to say the linking portions. These notches can be located only in these linking portions, so as to let the cheek portions of the capacity reserve remain between two notches defining the two linking portions of the same capacity reserve. It is however possible to link them by a cutout, particularly a curved cutout defining the edge of the cheek portions, so that these cheek portions have a lower radial height than that of the cheeks that delimit the bottom of the recess in the regions of the belt other than the capacity reserve. Conversely, it is possible to provide the cheek portions of the capacity reserve with a radial height greater than that of the cheeks of the other regions of the strip, for example by cutting out the edges of the strip in said other regions.

The present disclosure will be better understood and its advantages will appear better upon reading the following detailed description of one embodiment represented by way of non-limiting example.

### BRIEF DESCRIPTION OF THE DRAWINGS

FIG. 1 is a side view of a collar according to the present disclosure in the open state.

FIG. 2 is a perspective view of the collar of FIG. 1.

FIG. 3 is another perspective view of the collar of FIG. 1, taken from another angle.

FIG. 4 is a top view, along the arrow IV, of the collar of FIG. 1.

FIG. 5 shows the area Z of FIG. 1, taken along the arrow V indicated in FIG. 1.

FIG. 6 is a sectional view of FIG. 5 in the radial plane VI-VI.

FIG. 7 illustrates a possibility for placing the collar around an object to be clamped by means of the collar.

FIG. 8 shows a side view of the collar clamped on the object.

FIG. 9 is a sectional view in the plane IX-IX of FIG. 8.

FIG. 10 is a view similar to FIG. 5, for an alternative embodiment.

FIG. 11 is a side view, along the arrow XI of FIG. 10.

### DETAILED DESCRIPTION OF THE OBJECT OF THE DISCLOSURE

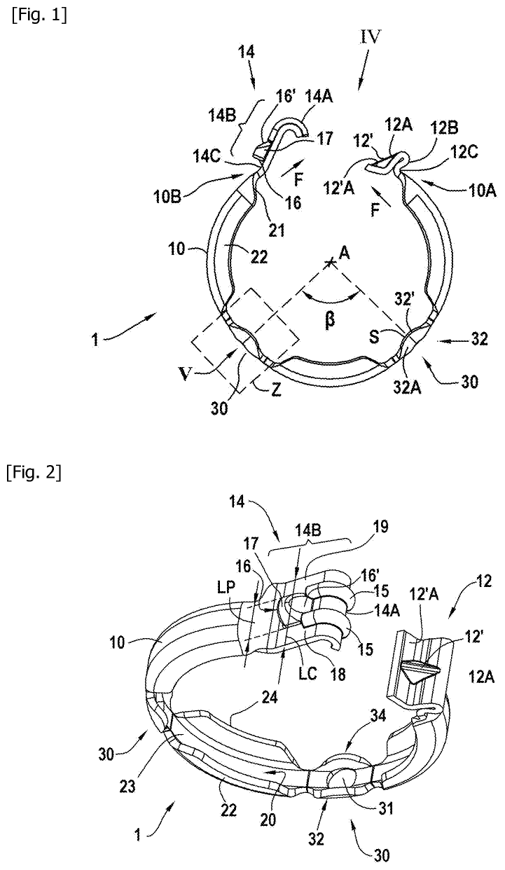

Referring to FIG. 1, it is seen that the clamping collar 1 has a belt 10 which, at a first end 10A, carries a lug 12 and, at a second end 10B, carries a hook 14. The collar is here represented at the open state, the hook not being hooked on the lug and the ends 10A and 10B being spaced apart. It is understood that when the collar is closed by hooking of the hook onto the lug, the belt delimits a cylindrical circumference centered on an axis A.

Thus, in the example represented, the collar is of the “open” type and can be closed and clamped by hooking of the hook onto the lug. The following description relates to a hook of a particular type, devoid of radial folds at its rear base. However, other types of hook could be provided, particularly a hook provided with a fold at its rear base, for example as in the patent application EP 0 636 826.

In addition, other closuring means are possible. For example, the collar could be of the tangential screw type, for example as in the patent application EP 0 305 232, EP 2 585 751 or EP 1 697 672.

It could also be a collar of the closed type, clamped by deformation of an element such as an inverted U-shaped lug.

In general, all types of clamping means could be provided. As will be seen below, it is advantageous for the capacity reserve according to the present disclosure to be present in these different types of collars. However, when its primary function is to adapt the circumference of the belt to dimensions of an object which, for example due to manufacturing tolerances, would be slightly greater than those for which the collar has been initially dimensioned, the capacity reserve is particularly interesting for collars whose clamping mode in itself does not allow changing its diameter, particularly for collars that are closed by hooking of a hook on a lug. In some cases, the clamping of a tangential screw collar may allow clamping the collar onto slightly different diameters, depending on the screw-in amount of the screw.

In the example represented, the closing and clamping of the collar are performed by means of the lug 12 and of the hook 14.

The lug 12 comprises in this case a double fold 12A, 12B, protruding radially outwardly with respect to the circumference of the belt and attached to the end 10A of this belt in 12C. The outer face of the front fold 12A has a stiffening rib 12′ which in this case extends up to an extension 12′A of the first end 10A located forwardly beyond the lug.

The hook has a front wall 14A and a common part 14B which is attached to the second end 10B of the belt in 14C. The front wall 14A is folded inwardly, that is to say towards the axis A, so as to be able to be hooked behind the lug 12 to keep the collar in the clamped state.

Conventionally, within the meaning of the present disclosure, an element facing away from the axis A will be referred to as “outer” element and an element oriented towards the axis A as “inner” element. Knowing that, to close the collar, the hook and the lug move relative to each other in the direction of the arrows F indicated in FIG. 1, an element of the hook will be referred to as “front” element when it is located forwardly in the direction of movement of the hook towards the lug for the clamping of the collar. An element of the hook will be qualified as “rear” when it is located on the contrary rearwardly in the same direction of movement. Similarly, regarding the lug, an element will be referred to as “front” element when it is located forwardly in the direction of movement of the lug towards the hook and “rear” element when it is located rearwardly in the same direction of movement.

The common part 14B of the hook is located at the rear of the front wall 14A and extends rearwardly from this front wall up to the area of connection 14C of the hook to the second end 10B of the belt. Thus, the common part 14B connects the front wall 14A to the belt 10.

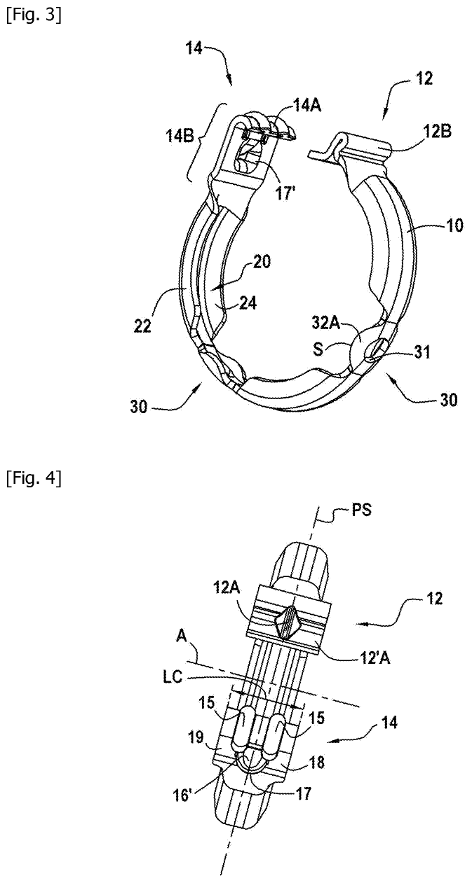

This common part 14B has a gripping surface 16 protruding radially outwardly. More specifically, considering FIG. 2, it is seen that two lateral borders, respectively 18 and 19, are located axially on either side of the gripping surface 16. Here, “axially” means in a direction along the axis A of the belt. It is seen that these two lateral borders are set back radially from the gripping surface 16. In this case, the gripping surface 16 is formed at the rear of a boss 17 present in the common part 14B, this boss resulting in a recess 17′ on the inner face of the common part 14B of the hook, as shown in FIG. 3.

The rear surface of the boss 17 is radially raised abruptly by forming a significant angle relative to the outer surface of the common part of the hook which is located immediately at the rear of this gripping surface, so as to provide a grip for a clamping tool, for example for the jaw of pliers.

On the other hand, the front part 16′ of the boss is connected in a gentler slope to the outer surface of the common part of the hook which is located at the front of the boss.

While the gripping surface forms an abrupt projection relative to the surrounding surfaces, the lateral borders of the common part of the hook are linked to the end 10B of the belt in the continuity of the latter, without radial folds outwardly. In this case, the lateral borders are substantially planar. As can be seen in FIG. 8, their outer surfaces define a plane P which is inclined at an angle α with respect to a plane T tangent to the outer circumferential surface of the belt 10, at the second end 10B of the latter, in the area 14C of attachment of the hook to the belt. The angle α is comprised between 5° and 60°, optionally between 10° and 40°. For example, the angle α can be on the order of 20°. The planes P and T, as well as the angle α mentioned above are represented in FIG. 8, in the closed state of the collar, while the hook is hooked behind the lug. Conventionally, the values indicated above for the angle α are measured in this situation in which the collar is closed. The lateral borders located on either side of the gripping surface 16 counteract the deformation of this gripping surface. In this case, these lateral borders counteract the deformation of the boss 17 in which the gripping surface 16 is formed. As this gripping surface provides a bearing plane to the clamping tool, it is unnecessary to provide the hook with a fold in the area of connection 14C with the end 10B of the belt. As indicated above, this connection is made in the continuity of the circumferential surface of the belt.

The gripping surface extends over a width LP (see FIG. 2) which is comprised between 20% to 70%, optionally between 30% and 50% of the width LC of the common part of the hook, these widths being measured axially, that is to say along the direction of the axis A. Thus, the lateral borders each have a width comprised between 15% and 40% of the width LC, optionally between 25% and 40% of this width LC. For example, the width of the common part of the hook is divided into equal or substantially equal three tiers, respectively occupied by a lateral border, the gripping surface and the other lateral border. In this case, the width LP of the gripping surface is also the width of the boss 17. These lateral borders form areas of the common part of the hook having sufficient material to provide the required mechanical strength. The boss 17, which has small dimensions, forms a work hardened area unlikely to be deformed.

In this case, the collar is symmetrical with respect to a plane of symmetry PS perpendicular to the axis A, as seen in FIG. 4. The gripping surface 16 is located in a central region of the width LC of the common part 14B of the hook, this width being measured parallel to the axis A. It can be seen in the figures that the boss 17 extends forwardly of the hook substantially up to the junction between the common part 14B and the front wall 14A.

In this case, the front wall 14 of the hook has at least one stiffening rib 15. In this case, this front wall has two stiffening ribs 15 located on either side of the plane of symmetry PS. It can be seen that the stiffening ribs 15 are linked to the front of the boss 17. Indeed, the front part 16′ of the outer surface of the boss naturally attaches to the ribs 15. Work hardened areas are thus constituted in the hook, which counteract its deformation. The boss 17 may have a relatively small width, as has been indicated, and therefore constitutes a highly work hardened area unlikely to be deformed. The presence of the lateral borders on either side of the boss reinforces the resistance of the common part of the hook to deformation. The ribs 15 extend in this case not only on the front wall, thus constituting strongly work hardened areas counteracting the deformation of this wall, but also up to the boss, thus counteracting a deformation of the bend between the front wall and the common part of the hook. The hook is thus particularly robust. Depending on the applications, the ribs 15 might not be present and the gripping surface could be made on an element other than a boss, for example by a tab raised relative to the surface of the common part. Indeed, the gripping surface as such is stressed only during the clamping operation of the collar, when it cooperates with the clamping tool. While this gripping surface must be able to have sufficient mechanical strength to allow the closing and the clamping of the collar, it is not necessary for this strength to be durable. However, the lateral borders ensure in the long term a mechanical strength of the common part of the hook preventing the elongation of the latter for the entire duration of maintaining the clamping on the clamped object by means of the collar.

The extension 12′A of the first end 10A of the belt was mentioned above. Depending on the applications, this extension could extend over a length greater than what is represented, for example over a length similar to that of the common part 14B of the hook so as to bridge said part inside the hook to ensure continuous bearing of the collar belt on the clamped object, even under the hook. Alternatively, it is possible to add a flange under the hook, or to produce the hook in a strip fixed to the second end of the belt, as illustrated, for a flat-strip collar, in European patent application EP 1 352 192 to ensure such continuous bearing.

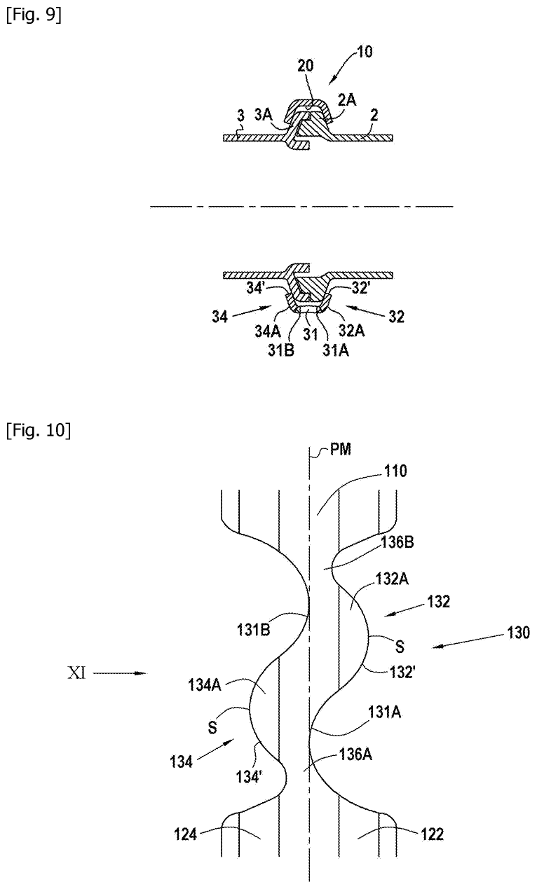

The belt 10 has an inner annular recess 20. For example, as shown in FIG. 9, the collar can be used to connect together two parts 2 and 3 of an object having annular protrusions 2A and 3A at their ends. It can be for example two tube portions 2, 3 whose ends, provided with annular protrusions, are brought against each other so that their annular protrusions can be received in the recess 20 of the collar belt.

As seen particularly in FIG. 2, the inner recess 20 has a bottom 23 delimited by cheeks respectively 22 and 24 which are oriented inwardly, that is to say towards the axis A of the belt. These cheeks form the axial limits of the annular recess 20; they are folded back towards the axis A of the collar relative to the outer periphery of the belt.

The recess in this case has a substantially U-shape, with a flat bottom 23, which delimits a cylindrical surface and relative to which the cheeks 22 and 24 are folded back. The recess could however have a V-shape. It can be provided, as in the example represented, that the recess has an overall U-shape, but that the cheeks, forming the branches of the U, are inclined relative to a radial plane perpendicular to the axis A, so as to diverge away from each other as they approach the axis A. Thus, the clamping of the collar on the object portions 2, 3 tends to bring the annular protrusions closer to each other 2A and 3A.

It can be seen in particular in FIG. 2 that the lateral borders 18 and 19 are at least partly formed in extensions of the cheeks 20 and 22, respectively, which are straightened so as to be oriented along the axis A. Thus, in the area 14C of connection of the rear part of the hook to the end 10B of the belt, the cheeks 20 and 22 are deformed to be brought back parallel to the axis A. These deformations constitute torsional bending areas 21 in which the material of the strip is strongly work hardened. They also contribute to the mechanical strength of the common part of the hook.

It is seen that the lateral borders 18 and 19 extend over the entire length of the common part 14B, from the junction of the hook with the belt 10 in the rear area 14C, up to the front wall 14A.

According to the disclosure, the clamping collar has at least one capacity reserve 30 formed by a portion of the belt 10 which is likely to elongate when the clamping tension of the belt exceeds a threshold value. In this case, two capacity reserves 30 are provided in two distinct areas of the belt. For example, these capacity reserves are angularly spaced at an angle β on the order of 50 to 180°, for example on the order of 90°.

The two capacity reserves being here identical, one of them is described. The capacity reserve 30 is delimited along the circumferential direction of the belt by liking portions 36 in which the cheeks 22 and 24 that delimit the inner recess 20 are interrupted. The capacity reserve is thus mechanically dissociated from the rest of the belt. It can be deformed through elongation along the circumference of the belt, while the rest of the belt does not elongate.

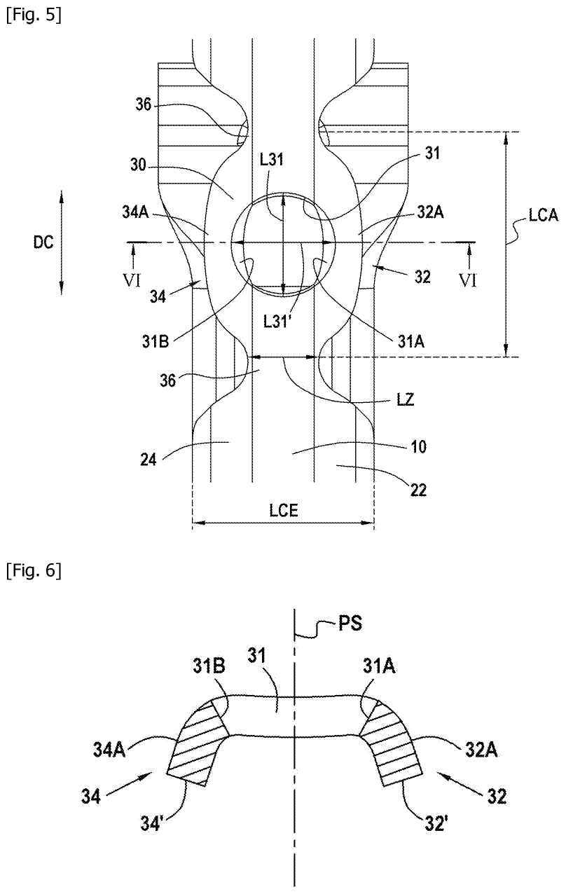

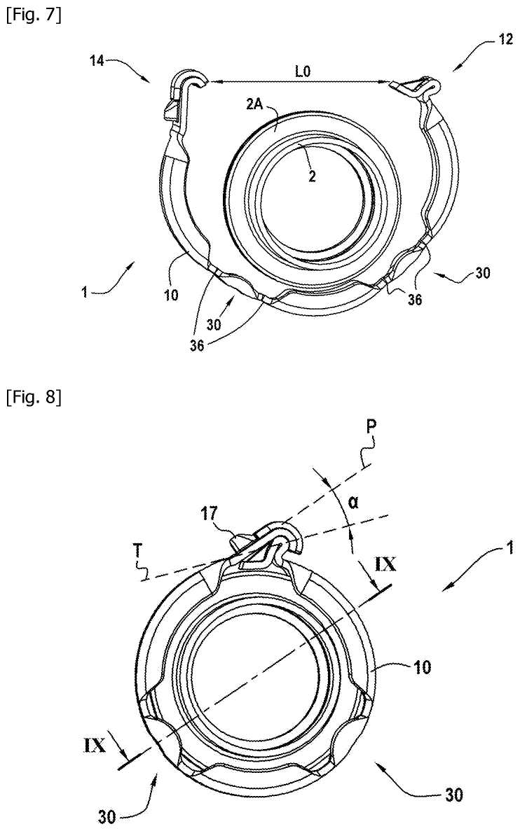

Furthermore, the linking portions can behave like hinges. Due to the interruption of the cheeks 20 and 22 in these linking portions 36, said linking portions have an amount of material smaller than the portions of the belt which have an equivalent length but are provided with cheeks. In addition, the linking portions 36 have in this case a width LZ (see FIG. 5) less than that of the belt. As can be seen in FIG. 7, the function of hinges of the linking portions, which are in this case 4 in number since there are two capacity reserves 30, allows widely opening the collar to promote its placement around the object 2, 3 it must clamp by a relative radial displacement between the collar and this object. In other words, in FIG. 7, the width LO of the cleared opening between the hook and the lug (which are here an example of means serving to close and clamp the collar) is here greater than the radial dimensions of the object 2, 3 and the collar can therefore be brought laterally around this object. However, this maximum opening does not harm the integrity and the mechanical strength of the collar since it is due to deformations of the latter in the linking portions that act like hinges. Moreover, the amount of material in these linking portions remains sufficient so that they are not easily deformable along the circumferential direction of the belt.

Although the cheeks 22 and 24 are interrupted in the linking portions 36, the capacity reserve 30 has cheek portions 32 and 34, which are also oriented towards the axis A of the belt 10. The cheek portions 32 and 34 are therefore in this case generally oriented like the cheeks 22 and 24. In this case, the cheek portions 32 and 34 have convex curved edges, respectively 32′ and 34′. Here, the cheek portions 32 and 34 are formed in lobes, respectively 32A and 34A whose apex S is located at mid-length of the capacity reserve 30.

Furthermore, it can be seen particularly with reference to FIG. 5 that the capacity reserve 30 has a deformable orifice 31. Under the effect of a high clamping tension, this orifice 31 can be deformed in its lengthwise direction, that is to say get larger along the circumferential direction DC of the belt 10. The edges 31A and 31B of the hole 31 define concave edge portions that can be deformed by a decrease in their curvature (that is to say an increase in their radius of curvature along the axis A) to allow the elongation of the capacity reserve 30. Like the hole 31, the edges 31A and 31B of this hole extend within the circumferential space requirement of the belt.

The lobes 32A and 34A are respectively located axially on either side of the hole 31. These two lobes are located in the same circumferential section of the belt which is also the section in which the hole 31 is located and its concave edge portions 31A and 31B. The apexes S of these lobes are located at mid-length of the capacity reserve 30 which, here, also corresponds to the mid-length of the hole 31. The hole here having a generally circular shape, the apexes S of the lobes are axially aligned with the area of the hole 31 in which its largest diametrical dimension parallel to the axis A is measured. Thus, the apexes S are located axially in line with a bottom area of the concavity of the concave edge portions 31A and 31B, the bottom area being the deepest area of the concavity, considered axially. The height of the lobes (measured radially) determines the amount of material present between the edge of the hole and the convex edge of the lobe. The shape of the lobe and the radial height of the cheek portion can be chosen to determine this amount of material so that the reserve capacity 30 elongates according to the desired amplitude for a determined value of the tension of the belt.

The orientation of the cheek portions 32 and 34 towards the axis A makes their deformations relatively difficult along the circumferential direction of the belt. The amplitude of deformation of the capacity reserve is therefore moderate. As seen in FIG. 6, the edges 31A and 31B of the orifice 31 which are opposite along the direction of the axis A are inclined with respect to a plane perpendicular to this axis A, for example with respect to the previously mentioned plane of symmetry PS. In this case, this is achieved by the fact that the cheek portions 32 and 34 encroach locally on these edges of the orifice 31. This inclination contributes to the distribution of the tensile forces within the cheek portions. However, the cheek portions could not encroach on the edges of the orifice by then being completely located axially on either side of the edges 31A and 31B, whereas they are so only partly in the example represented.

The lobes 32A and 34A in which the cheek portions are formed have a generally convex shape which favorably impacts the distribution of the tensile forces within the cheek portions.

In this case, the hole 31 has a generally circular shape. It is the shape that it has before the capacity reserve is deformed by elongation of this hole. Particularly, the hole can be formed by a cylindrical punch.

In this case, the hole 31 has a significant portion of the capacity reserve 30. Thus the hole 31 has the following geometric characteristics (i) and (ii):
the hole 31 has a length L31 at least equal to 30% of the length LCA of the capacity reserve 30, these lengths being measured along the circumferential direction of the belt (characteristic (i)); and
the hole 31 has a width L31′ at least equal to 50% of the width LCE of the belt, these widths being measured along the direction of the axis of the belt (characteristic (ii)).

It can be expected that only one of the characteristics (i) and (ii) is present.

These geometric characteristics of the hole are verified in the non-elongated state of the capacity reserve. The length L31 of the hole is in this case its diameter, the hole being circular. In general, this length is its maximum length, measured right through the hole, parallel to the circumferential direction of the belt. In general, this length is measured in the plane PS. The width L31′ of the hole is in this case its diameter, the hole being circular. In general, this width is its maximum width, measured right through the hole, parallel to the direction of the axis A.

Here, the length LCA of the capacity reserve 31 is measured between the two linking portions 36. In this case, the interruption of cheeks 22 and 24 in these linking portions giving their edges concave shapes, the length LCA is measured between the bottoms (recessed apexes) of these concavities, that is to say between the two areas in which the minimum width LZ of the linking portions 36 is measured.

In addition, the width LCE of the belt is measured parallel to the axis A, from one edge to the other of this belt, including the cheeks 32 and 34 in this measurement.

It is noted that the areas of the capacity reserve which border the hole 31 remain in the general geometry of the belt. Indeed, the concave edge portions, in this case formed by the edges of the hole 31, are substantially located in the continuity of the inner surfaces of revolution of the recess (cylindrical bottom of the recess and annular inner faces of the cheeks), which allows a bearing continuity of the belt of the collar on the clamped object, even in the region of the capacity reserve. The hole only very locally interrupts this bearing continuity and this interruption is neutralized by the inner surfaces that border the hole. It can be provided that the cheek portions 32 and 34 have an initial inclination, with respect to a radial plane perpendicular to the axis A, such as the plane PS, which is slightly different from the inclination of the cheeks 22 and 24 with respect to the same plane. For example, the cheek portions 32 and 34 could be folded back towards the axis A slightly more than the cheeks 22 and 24, so as to pre-stress the capacity reserve during clamping.

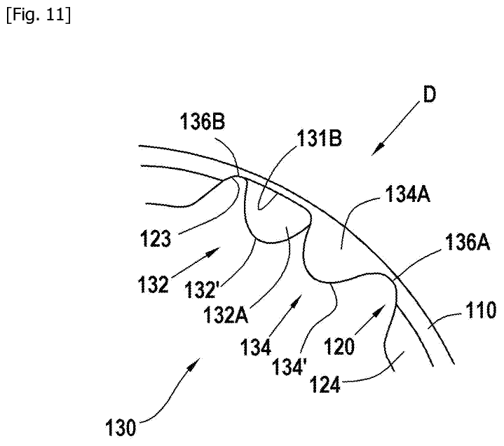

FIGS. 10 and 11 are now described, which represent a portion of the belt 110 of the collar whose inner recess 120 can be seen with its bottom 123 delimited by the cheeks 122 and 124 oriented towards the axis of the belt.

The belt portion represented includes a capacity reserve 130 delimited by linking portions 136A, 136B in which the cheeks 122 and 124 are interrupted.

The capacity reserve 130 has cheek portions 132, 134 oriented towards the axis of the belt and at least one concave edge portion, in this case two concave edge portions 131A and 131B. In this case, these concave edge portions are not formed by the edges of a hole. Viewed from the outside, along the direction of the arrow D in FIG. 11, the capacity reserve has a wave shape. Considered from bottom to top in FIG. 10, following the circumferential direction of the belt, the capacity reserve has a first concave edge portion 131A which extends, towards the median plane PM of the belt perpendicular to its axis A, in the continuity of the edge of the linking portion 136A in the interrupted part of the cheek 122, and a second concave edge portion 131B, which extends towards the median plane PM of the belt in the continuity of the edge of the linking portion 136B in the interrupted part of the cheek 124. The two concave edge portions 131A and 131B therefore extend over the two axially opposite edges of the belt and are offset relative to each other along the circumference of the belt. The two cheek portions 132 and 134 are also offset relative to each other along the circumference of the belt. In this case, the cheek portion 132 extends at least partly in the same circumferential section as the concave edge portion 131B, and the cheek portion 134 extends at least partly in the same circumferential section as the concave edge portion 131A, but these two circumferential sections are different. However, the two cheek portions 132 and 134 are here totally located axially on either side of each of the concave edge portions 131A and 131B. As in the example of FIGS. 1 to 9, the elongation of the capacity reserve is made by a deformation of the concave edge portions which then tend to straighten while reducing their curvatures. It is seen that in this case, the concave edge portions encroach on the width (measured axially) of the bottom 123 of the recess 120.

The cheek portions 132 and 134 are formed in lobes 132A and 134A, respectively, and have convex curved edges 132′, 134′. The apexes S of the respective lobes 132A and 134A can be offset relative to the bottom area of the respective concave edge portions 131A and 131B as represented, or on the contrary be located axially in line with these bottom areas.

In the two examples which have just been described, the concave edge portions have smooth curved shapes. They could however have angular shapes. For example, the edges of the hole 31 could have a polygonal shape.

The collar could of course have only one capacity reserve or on the contrary have more than two capacity reserves. Optionally, several capacity reserves could be provided in the continuity of each other, a linking portion delimiting the end of a capacity reserve being at the same time able to delimit the beginning of the adjacent capacity reserve. These different capacity reserves can be similar or on the contrary different, for example by having cheeks and concave edge (hole) portion(s) different in shape or number.

The length of a capacity reserve 30 or 130 is relatively small compared to that of the belt. For example, the length of the or each capacity reserve is comprised between 5% and 25% of the diameter of the belt in the clamped state, preferably between 10% and 20% of this diameter. The length of the or each concave edge portion of the capacity reserve, defined as being the length of the projection of this edge in a plane perpendicular to the axis A of the belt (PS or PM planes), is conventional on the order of 20% to 100% of the length of the capacity reserve, particularly on the order of 25% to 70% of the length of the capacity reserve. In particular, the length of the or each concave edge portion is for example on the order of 2% to 20%, particularly on the order of 5% to 15%, of the diameter of the belt in the clamped state.

In the example which has just been described, the collar is made in one piece from a metal strip.

1. A clamping collar comprising a metal belt configured to be clamped on an object, the belt having an inner recess comprising a bottom delimited by cheeks oriented towards an axis of the belt, the clamping collar comprising a capacity reserve, formed by a portion of the belt configured to elongate under an effect of a clamping tension of the belt, the capacity reserve being delimited, along a circumferential direction of the belt, by linking portions in which the cheeks are interrupted and the capacity reserve comprising cheek portions oriented towards the axis of the belt.

2. The clamping collar according to claim 1, wherein the cheek portions have convex curved edges.

3. The clamping collar according to claim 1, wherein the capacity reserve has at least one concave edge portion.

4. The clamping collar according to claim 3, wherein the cheek portions are at least partly located axially on either side of said concave edge portion.

5. The clamping collar according to claim 3, wherein the concave edge portion extends within a circumferential space requirement of the belt.

6. The clamping collar according to claim 3, wherein the capacity reserve comprises at least one hole.

7. The clamping collar according to claim 6, wherein the hole extends up to the cheek portions.

8. The clamping collar according to claim 6, wherein the hole has at least one of the following geometric characteristics:
a length at least equal to 30% of a length of the capacity reserve, these lengths being measured along the circumferential direction of the belt, and
a width at least equal to 50% of a width of the belt, these widths being measured along the direction of the axis of the belt.

9. The clamping collar according to claim 1, wherein the cheek portions are formed in lobes.

10. The clamping collar according to claim 9, wherein the capacity reserve has at least one concave edge portion, and wherein at least one of the lobes has an apex located axially in line with a bottom area of a concavity of the concave edge portion.

11. The clamping collar according to claim 1, wherein the belt carries a protruding lug in the vicinity of a first end and a hook in the vicinity of a second end, the hook having a front wall and a common part, the front wall being intended to be retained behind the lug while the hook is hooked on the lug to keep the collar in a clamped state, the common part linking the front wall to the belt and having a gripping surface protruding radially outwardly and two lateral borders which extend axially on either side of the gripping surface by being radially set back from the gripping surface.

12. The clamping collar according to claim 11, wherein the gripping surface is formed at the rear of a boss of the common part.

13. The clamping collar according to claim 1, formed in one piece from a metal strip.
